(19) United States
(12) Patent Application Publication
(10) Pub. No.: US 2015/0019418 A1
(43) Pub. Date: Jan. 15, 2015

(54) SYSTEMS, METHODS, AND COMPUTER PROGRAM PRODUCTS FOR ENABLING INSTRUMENT CREDENTIALS

(71) Applicant: JVL VENTURES, LLC, New York, NY (US)

(72) Inventors: Matt Hotard, New York, NY (US); Ryan L. Watkins, Brooklyn, NY (US)

(73) Assignee: JVL VENTURES, LLC, New York, NY (US)

(21) Appl. No.: 14/288,776

(22) Filed: May 28, 2014

Related U.S. Application Data
(60) Provisional application No. 61/845,684, filed on Jul. 12, 2013.

(51) Int. Cl. G06Q 20/36; G06Q 20/38

(52) U.S. Cl. CPC G06Q 20/36; G06Q 20/3821
USPC 705/41

(57) ABSTRACT

Systems, methods, and computer program products are provided for enabling instrument credentials on a secure element. Application identifiers of credentials are stored on at least one memory. An input to an interface causes an instrument representation corresponding to a set of credentials to be displayed on the interface. The application identifier of the displayed instrument is retrieved from the memory and transmitted in a request to a secure element to enable an applet corresponding to the application identifier. A response is received indicating whether the applet corresponding to the application identifier is enabled.

### CROSS REFERENCE TO RELATED APPLICATIONS

This application claims priority to U.S. Provisional Application No. 61/845,684, filed Jul. 12, 2013, the contents of which are incorporated herein by reference.

### BACKGROUND

1. Field

The present invention generally relates to mobile wallet applications and applets in mobile devices. More particularly, the present invention relates to systems, methods, and computer program products for enabling instrument credentials in mobile wallet applications.

2. Related Art

Mobile wallet applications are used in a mobile commerce environment to conduct transactions using a mobile device without the need for physical cash, checks, credit cards, tickets, coupons, or the like. The transactions can be either financial transactions (e.g. payments) or non-financial transactions (e.g. venue admissions).

Credentials used to effect such transactions can be associated with instruments such as credit cards, debit cards, loyalty cards, coupons, tickets, and the like, issued by a service provider, such as a bank, merchant, card association, and the like. These credentials are also linked or associated with applets on the mobile device, particularly the applets corresponding to the respective service providers' instrument.

A mobile device may have multiple applets, each of which is typically not initially enabled for use, for security and resource saving purposes. Credentials associated with such an applet must be linked (e.g. provisioned) for the applet to be enabled and ready to transact with a reader and/or terminal that is also enabled to communicate or otherwise transact with the applet. Once the credentials are linked to their associated applet, the desired applet can be enabled on a mobile device, thus making the applet and associated credentials authorized to conduct a transaction. The mobile device can then be used to conduct a transaction, such as a contactless payment, at a point-of-sale equipped with a near field communication (“NFC”) enabled reader module or the like.

One technical challenge involves reducing the number of inputs and/or user interactions, as well as the length of time, required to enable an applet associated with credentials for a transaction. By linking multiple sets of credentials to multiple applets on the customer's mobile device, a risk exists that multiple interactions with the mobile device would be required to enable the appropriate applet and associated credentials. As a consequence of these numerous interactions, there would be more delay in the transaction process.

Mobile wallet users or customers would prefer to limit the number of interactions required to enable credentials to be used in a transaction. The mobile wallet provider, in turn, would prefer that the application be capable of enabling the applet associated with the credentials securely and with minimal user-mobile device interaction.

### BRIEF DESCRIPTION

The present invention provides systems, methods, and computer program products for enabling instrument credentials.

In one embodiment, a system for enabling instrument credentials includes at least one memory, an interface, and at least one processor communicatively coupled to the memory and the interface. Application identifiers (AIDs) corresponding to instrument images and their associated credentials in a mobile wallet application are stored in the memory of the mobile device, as well as the memory of a secure element. An input is received via the interface which includes instruction to display an instrument image, and the AID corresponding to instrument image displayed on the interface is retrieved from the memory. A request is transmitted to a secure element to enable an applet corresponding to the AID. The mobile wallet application receives a response from the secure element indicating whether the applet is enabled.

In another embodiment, a method for enabling credentials includes: receiving an input, from an interface, which includes instructions to display an instrument image which is associated with credentials; retrieving, from a memory, an AID corresponding to the instrument image displayed on the interface; transmitting a request to a secure element to enable an applet corresponding to the AID; and receiving a response from the secure element indicating whether the applet is enabled.

In another embodiment, a non-transitory computer-readable medium has stored thereon sequences of instructions for causing one or more processors to: receive an input from an interface; retrieve, from a memory, an AID corresponding to an instrument image displayed on the interface; transmit a request to a secure element to enable an applet corresponding to the AID; and receive a response from the secure element indicating whether the applet is enabled.

### BRIEF DESCRIPTION OF THE DRAWINGS

The features and advantages of the present invention will become more apparent from the detailed description set forth below when taken in conjunction with the following drawings.

FIG. 1 is an illustration of a system for enabling credentials according to an example embodiment.

FIGS. 2A-2D are graphical representations of an interface during the process of enabling credentials according to an example embodiment.

FIG. 3 is a sequence diagram illustrating a process for enabling credentials according to an example embodiment.

FIG. 4 is a block diagram of a device for use with various example embodiments of the invention.

### DETAILED DESCRIPTION

### I. Overview

The example embodiments of the invention presented herein are directed to systems, methods, and computer program products for enabling credentials in secure elements. Some of the embodiments are described below in terms of an example system in a mobile commerce environment. This is for convenience only and not intended to limit the application of the present invention. After reading the following description, it will be apparent to one skilled in the relevant art(s) how to implement the following invention in alternative environments, such as ticketing, venue admissions, identification, and the like.

An instrument (or product) is used to refer to a credit card, debit card, gift card, general purpose reloadable card, loyalty customer card, ticket and the like, associated with an account, offer, or license.

The term “credentials” and “set of credentials” are used to refer to the information associated with an instrument required to use the associated instrument in a transaction. For example, credentials could be a credit card number, security code, and expiration date.

The terms “application,” “applet,” and/or the plural form of these terms are used interchangeably herein to refer to an application (functioning independently or in conjunction with other applications) or set or subset of computing instructions, which when executed by one or more processors, causes the processor(s) to perform specific tasks.

The terms “activate,” “enable,” “arm,” and/or the plural form of these terms are used interchangeably herein to refer to the act of authorizing. For example, enabling an applet associated with a set of credentials authorizes those credentials for a contactless transaction.

The phrases “enable an applet associated with a set of credentials” and “enable credentials” are used interchangeably herein to refer to the act of authorizing credentials associated with an instrument to be sent in a transaction.

Generally, a mechanism is provided for enabling an applet associated with a set of credentials in a secure element. An instrument is associated with credential information required to use the instrument in a transaction. For example, a credit card is associated with a credit card number, expiration date, card verification value (“CVV”), etc.; any combination of this information is the set of credentials associated with the credit card and/or an applet stored on a secure element of the mobile device.

Particularly, an instrument image representative of, for example, a card, ticket, offer or account associated with the instrument is selected via an input on the interface of a mobile device having a mobile wallet application (hereinafter “mobile wallet”). The credentials, as discussed above, are associated with or linked to an applet stored on a secure element of the mobile device. When the instrument image is selected via an input to the interface, the mobile device processor requests the corresponding applet associated with the credentials in the secure element to be enabled.

Credential information of a corresponding instrument is set up (e.g., provisioned) via the interface of the mobile wallet. The information is stored on the dedicated memory of the secure element, and each set of credentials corresponds to an applet within the secure element. Each applet corresponding to the credentials is assigned its own unique application identifier (AID), which is stored on the memory of the mobile device and the memory of the secure element. An instrument image representative of a physical form factor associated with the instrument (e.g., card, account, ticket, etc.) corresponding to the credentials is created and stored in the memory of the mobile device. This instrument image is stored within an instrument carousel on the mobile wallet, as shown in more detail below. The instrument image corresponding to the credentials is associated with the same AID as the applet corresponding to the credentials. The AID is used for mapping of the instrument image on the mobile wallet, the instrument image stored on the mobile device memory, and the applet corresponding to the credentials stored on the secure memory corresponding to the instrument image.

In one embodiment, a first set of credentials is enabled when an input to the interface causes the mobile wallet to be opened and a first instrument (e.g., credit card) image corresponding to the first set of credentials to be displayed. The mobile wallet, via the mobile device processor, identifies and/or retrieves the AID from the mobile device memory corresponding to the instrument image displayed on the interface. The processor transmits a request to the secure element to enable an applet corresponding to the identified and/or retrieved AID. The mobile wallet receives a response from the secure element indicating whether the applet has been enabled.

In an alternative embodiment, an input to the interface causes (1) the first instrument image corresponding to a set of credentials to be removed from display on the interface, and (2) a second instrument image corresponding to a second set of credentials to be displayed. The input that causes the second instrument image to be displayed also causes the second set of credentials to be enabled, without any need for further input. The first set of credentials is disabled in the secure element, and the second set of credentials is enabled as described above.

In an alternative embodiment, no instrument image is displayed on the interface when the mobile wallet is opened. The input to the interface causes a first instrument image corresponding to a first set of credentials to be shown on the interface. The input that causes the instrument image to be displayed also causes the set of credentials to be enabled, without any need for further input. The first set of credentials is enabled as described above. The first set of credentials may be disabled, and a second set of credentials may be enabled, also described above.

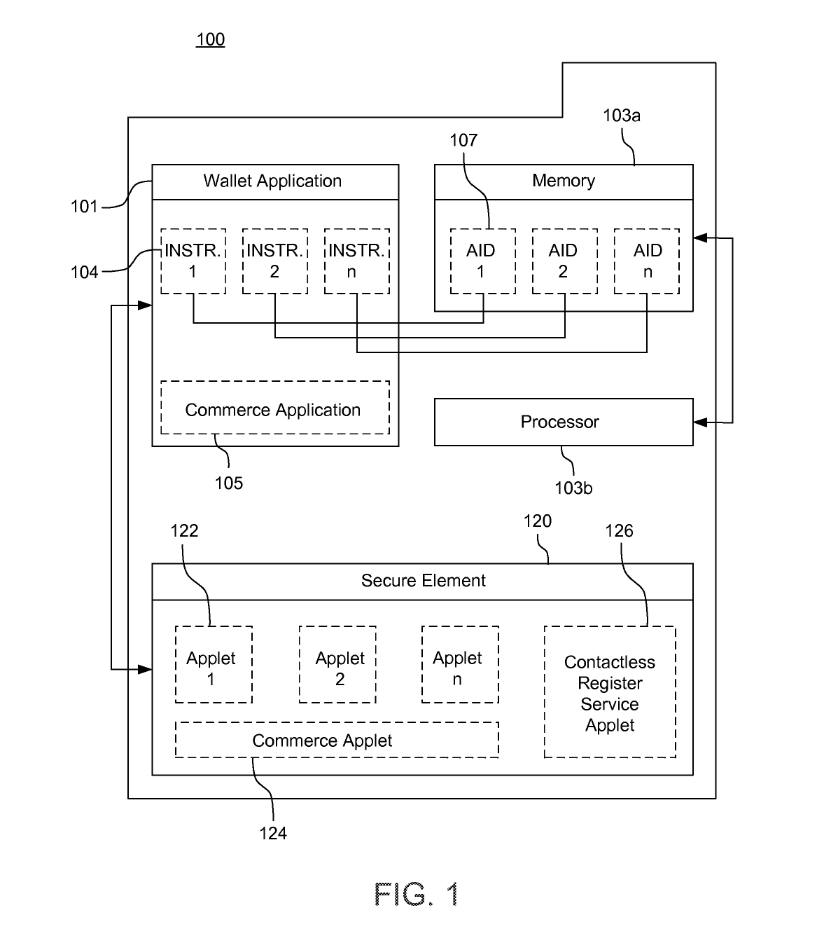

The features discussed above are described in further detail below, with reference to FIGS. 1-4.

### II. System

FIG. 1 is a diagram of a system for enabling credentials according to an example embodiment. As shown in FIG. 1, the system includes a mobile device 100, a secure element 120, and a mobile wallet application 101.

The mobile device 100 may be, for example, a cellular phone, a tablet, or the like, and includes a processor 103a, a memory 103b, and an interface such as a display. The mobile device 100 also includes the secure element 120, which may be implemented as a Universal Integrated Circuit Card, embedded SE card, secure micro secure digital card, and the like. The secure element 120 is generally considered secure because it is a self-contained system, including dedicated memory, and is protected by hardware and software hardening techniques that are verified by independent testing.

The secure element need not be arranged as hardware within the mobile device 100. The secure element may be implemented as a “virtual” secure element. The virtual secure element may be maintained outside the mobile device on any memory accessible to the mobile, including but not limited to, for example, a remote server or computer, in the cloud, etc.

The secure element 120 includes applets (Applet 1, Applet 2, . . . , Applet n, collectively referred to herein as “applets 122”) corresponding to the instrument images (Instrument 1, Instrument 2, . . . , Instrument n, collectively referred to herein as “instruments 104”) saved in the mobile wallet 101 and stored in the memory 103b of the mobile device 100. The secure element may also include commerce applet 124 and a Contactless Registry Service (CRS) applet 126. The CRS is configured to manage and provide access to applications such as payment applets 122. The CRS applet 126 is configured to provide application management, including management of the CRS, to an end user.

The mobile wallet application 101 (hereinafter “mobile wallet 101”) includes computer executable instructions that, when executed by the processor 103b of the mobile device 100, allow the mobile device 100 to be used as a transaction instrument. For example, the mobile device 100 can be used for processing transactions such as contactless commerce and/or payment transactions by means of near-field communication. The mobile wallet 101 may include instruments 104 and a commerce application 105.

In an example embodiment, the mobile wallet 101 allows consumers to manage instruments such as credit cards, debit cards, reloadable general purpose cards, and the like. The mobile wallet 101 manages these instruments, for example, by processing inputs into the display or interface of a mobile device 100. The mobile wallet 101 maintains application identifiers (AIDs) 107 in the memory 103a of the mobile device 100 corresponding to the instruments 104 stored in the mobile wallet 101.

The commerce application 105 is a component of the wallet application 101 that allows consumers to manage commerce instruments, such as loyalty cards, offers, rewards, coupons, and the like. The commerce application 105 manages these instruments, for example, by processing inputs into the display or interface of a mobile device 100. The commerce application 105 maintains a master list of commerce elements in the memory 103a of the mobile device. When a commerce instrument(s) is selected to be used in a commerce transaction, the commerce application 105 moves the commerce instrument(s) to the secure element 120. Some commerce instruments, such as those containing sensitive information (e.g. loyalty card information) can be stored on the secure element 120 rather than the memory 103a.

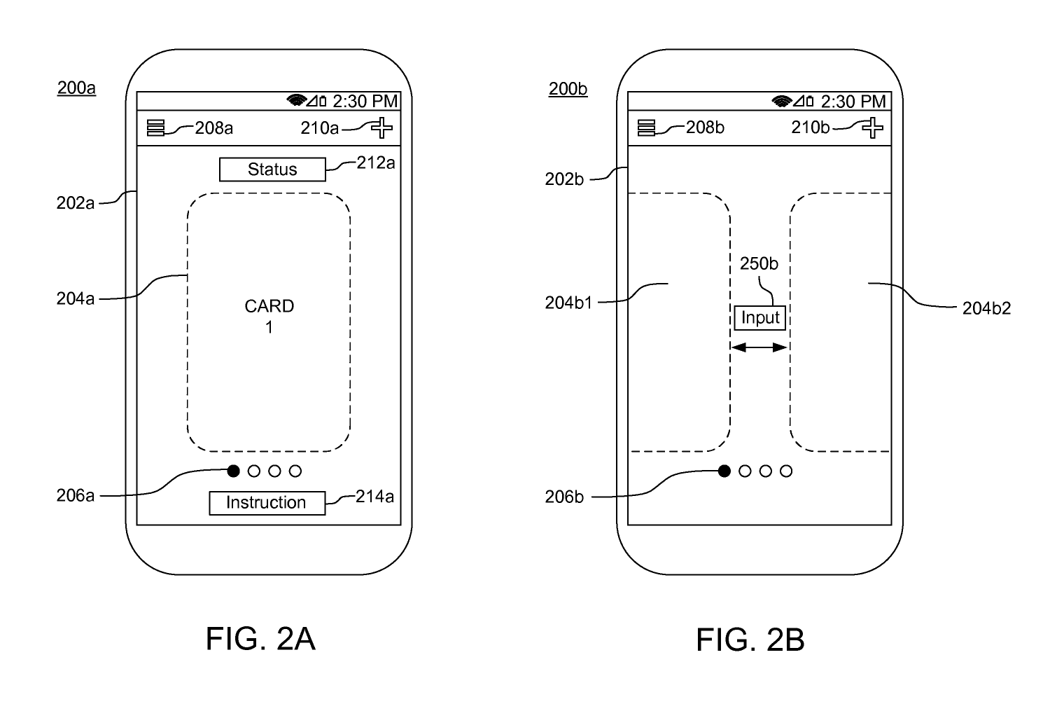

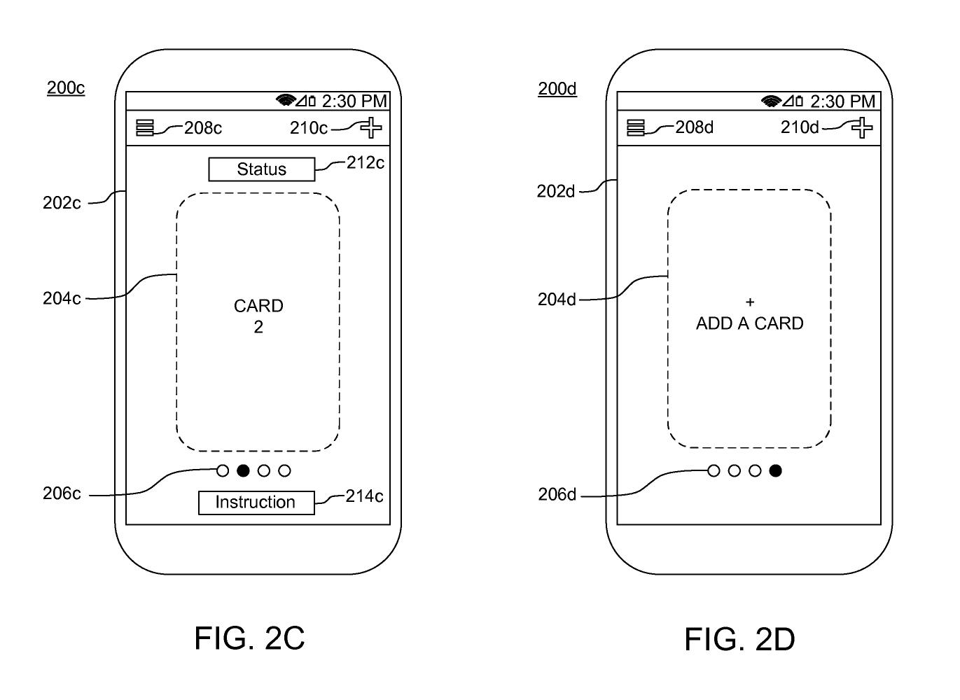

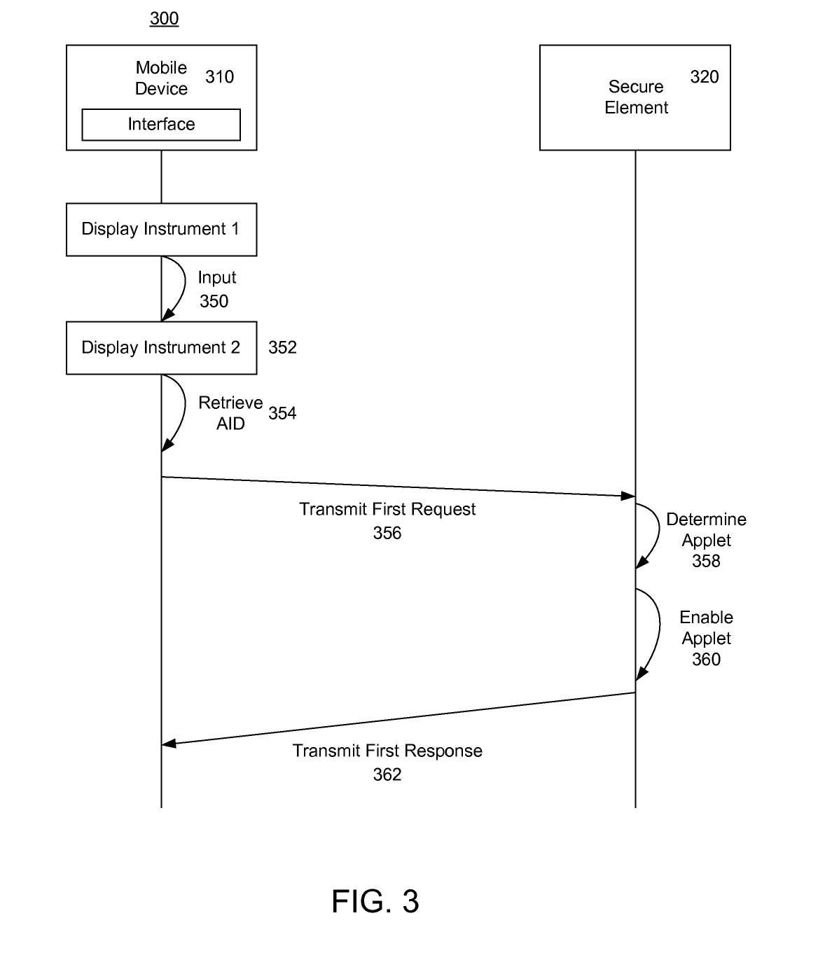

The mobile wallet 101 receives an input from the display or interface of the mobile device 100. The input displays an instrument 104 on the interface and causes the mobile wallet 101 to send a request to the secure element 120 to enable the applet 122 corresponding to the instrument 104 displayed. This request to enable the applets is discussed in further detail below with reference to FIGS. 2A-D and FIG. 3.

### III. Process

1. Loading Instruments

The example embodiment is described in terms of an example system in a mobile commerce environment. In this example, the instruments are cards associated with a transaction account. FIG. 2D illustrates a mobile device including an interface for adding an instrument and instrument image corresponding to a card to a mobile wallet. The addition of a card to the mobile wallet also adds a corresponding set of credentials to the secure element. It should be understood that any type of payment, commerce, or other instrument, including, for example, a credit card, debit card, loyalty card, coupon, ticket, identification, and the like, can be alternatively and/or additionally added to the mobile wallet.

As shown in FIG. 2D, a mobile device 200d includes an interface 202d. The mobile device 200d also includes a mobile wallet (not illustrated) into which cards can be added for use in contactless transactions.

A card carousel is a list of card images corresponding to cards or accounts in a mobile wallet which can be scrolled through (e.g., by swiping) to display the next card image on the carousel. For example, the list of card images can be horizontal or vertical, and the scrolling can be accomplished by a horizontal swipe from right to left or vice versa, or a vertical swipe from the bottom to the top or vice versa. A prompt (e.g., button, icon, etc.) to add a card to the mobile wallet and the card carousel is displayed on the interface 202d, for example, when the end of the carousel is reached. For example, in FIG. 2D, the outline of a card 204d is displayed on the interface 202d. By interacting with the interface 202d, a user of the mobile device 200d can elect to add a card, for example, by clicking an “Add Card” section and/or the card outline 204d within the card carousel. The card carousel status indicator 206d displayed on the interface 202d of the mobile wallet indicates which card image on the card carousel is being displayed.

The adding of a card to a mobile wallet may be executed in accordance with a mobile wallet issuer's requirements. In one embodiment, steps for adding a card to a mobile wallet include collecting data, communicating data among mobile wallets, mobile devices and service providers, and displaying an added card (e.g., its corresponding image) on the mobile wallet interface. For example, U.S. patent application Ser. No. 13/848,962 ('962 application), entitled “Systems, Methods, and Computer Program Products for Provisioning Payment Accounts into Mobile Wallets and Managing Events,” which is incorporated herein by reference in its entirety, describes a process for equipping mobile devices, such as a phone or tablet, with service accounts, such as credit card, debit, and banking accounts.

2. Enabling the Credentials

FIGS. 2A-D illustrate an interface of a mobile device which may be used for enabling credentials. FIGS. 2A-D further illustrate a card carousel having three card images and a card outline for adding a card, as described above with reference to FIG. 2D.

FIG. 2A illustrates a first card image 204a being displayed on the interface 202a of a mobile device 200a, for example, when the mobile wallet is opened. In an alternative embodiment, as shown in FIG. 2D, the “Add Card” outline 204d may be displayed when the mobile wallet application is opened. In FIG. 2A, the first card image 204a is one of any number of card images stored in a card carousel. The card carousel allows a user, via an input, to scroll between the stored cards, as well as the Add Card outline 204d for adding a card, within the mobile wallet application.

In FIG. 2A, the card image 204a is displayed on the interface 202a when the mobile wallet application is opened. The credentials associated with card 204a may be automatically enabled. When the mobile wallet application is opened, the card 204a that is displayed is automatically selected without any further input to the interface 202a. The credentials associated with the displayed card 204a are automatically enabled as a result of the card 204a being displayed on the interface 202a, as discussed in further detail below.

The interface 202a may include a navigation menu button 208a, and a commerce button 210a. The navigation menu button 208a may include a list of options available to the mobile wallet user, such as a manage cards option, a settings option, a lock wallet option, a help option, a home option, and the like. These menu options allow a user to customize settings within the mobile wallet. For example, the manage cards option may allow a user to delete a card, whereas the setting option may allow a user to change the passcode required to enter the mobile wallet application.

The commerce navigation button 210a may include a list of commercial options available to the mobile wallet user, such as options to include other instruments, such as a loyalty card, coupon, or the like, to the card carousel to be used in the transaction. A user may use the commerce navigation button 210a to add an additional instrument via the mobile device interface 202a. After the additional instrument is added, the additional instrument may be stored in a submenu of the commerce menu. For example, a user may use the commerce navigation button 210a to add a loyalty card via the mobile device interface 202a. After a loyalty card is added, the loyalty card may be stored in a loyalty card submenu of the commerce menu. A user may select a loyalty card to be used in a contactless transaction, and a loyalty card image corresponding to the loyalty card will be added behind the displayed primary card image 204a in the card carousel.

A user may alternatively or additionally browse coupons and offers of merchants in the commerce navigation menu. A user may browse, for example, based on favorite stores, proximity (i.e. offers close to current location), and the like. The user may then select an offer to be added to a contactless transaction, and an offer image corresponding to the offer will be added to the card carousel behind the primary card image 204a. Any commerce option selected by the user and added to the card carousel may be depicted by a card module representation behind the displayed primary card image 204a. This card module representation is similar to the representation of the primary card image 204a, but is offset behind the primary card representation so the commerce option is visible to the user. This offset may be accomplished by, for example, either rotating the card a predefined amount, or by offsetting the commerce card images (i.e. loyalty card, coupon, offer, etc.) to the left or right of the displayed primary card image 204a. When a user changes which primary credentials to enable (i.e. by displaying the next or previous card image associated with the credential), as described in more detail below, the commerce card images will be added behind the next (or previous) displayed primary card image.

The interface 202a may also include a status indication 212a that details the status of the credentials corresponding to the card image 204a displayed on the interface. For example, the status 212a may indicate that the credentials are enabled (i.e. ready to be used) in a contactless transaction. Alternatively, the status 212a may indicate that the credentials corresponding to card image 204a shown on the interface are being loaded (i.e. in the process of being enabled). The status may also indicate that the credentials are disabled, which results from an error in the enabling process.

The interface 202a may also include an instruction indication 214a that explains the various options available to the user. For example, the instruction indication 214a may instruct the user to perform an input to change to the next card image 204a in the carousel. Alternatively, or in addition to the input instruction, the instruction indication 214a may instruct the user to perform a contactless transaction.

FIG. 2B is an illustration of the interface when an input 250b is received by the mobile device 200b. Although illustrated on FIG. 2B, the input 250b need not be displayed on the interface and may instead represent the type of input used to interact with the interface. For example, a swipe is considered an input, but it is not displayed on the interface. The input 250b may be received, for example, when a user operating the mobile device 200b interacts with the interface 202b of the mobile device. In one example embodiment, the user's interaction and resulting input 250b may be a swipe from one card image 204b1 to another card image 204b2 from right-to-left or left-to-right.

In an alternative example embodiment, the interface may be divided into one or more predefined areas, for example a left predefined area and a right predefined area. The user's interaction and resulting input 250b may be a tap in one of the predefined areas. For example, the tap input 250b to the right predefined area may result in progressing to the next card image 204b2 in the card carousel (i.e. changing from a first card image 204b1 to a second card image 204b2). Alternatively, the tap input 250b to the left predefined area may result in regressing or progressing to the previous card image 204b1 in the card carousel (i.e. changing from a second card image 204b2 to a first card image 204b1).

The input 250b to the interface 202b causes a first card image 204b1 to be removed from display, and may cause a second card image 204b2 in the card carousel to be displayed on the interface, as shown in FIG. 2C. In FIG. 2C, a second set of credentials corresponding to the second card image 204c is automatically enabled as a result of the second card image 204c being fully displayed on the interface, without any further input to the interface 202c. In other words, a second input expressly selecting the card being displayed is unnecessary to enable the corresponding credentials, as the credentials are enabled upon the card image 204c being displayed.

The interface 202c may include a status indication 212c which notifies the user of the mobile device 200c of the status (i.e. enabled, loading, disabled, etc.) of the second set of credentials corresponding to the second card image 204c displayed on the interface 202c. The interface 202c may also include an instruction indication 214c which advises the user with its available options (e.g. input for next/previous card, perform contactless transaction, etc.).

In another example embodiment, as shown in FIG. 2D and described above in further detail, the input to the interface causes a first card image to be removed from display, and may cause an add card outline 204d in the card carousel to be displayed on the interface 202d. The add card outline 204d allows a user, via the mobile wallet, to add additional cards and card images to the card carousel, as described above. When this option is displayed on the interface 202d, no card images in the card carousel are displayed, and thus, no credentials are ready for a contactless transaction. The add card outline 204d can be the first card in the card carousel, or, as shown in FIG. 2D, it can be the last card in the carousel, or anywhere in between.

FIG. 3 is a sequence diagram 300 illustrating the process for enabling credentials. At step 350, a mobile device 310 (e.g. FIG. 1, mobile device 100) receives an input 350. An input 350 may be received, for example, when a user operating the mobile device 310 interacts with the interface of the mobile device 310. As described above with reference to FIG. 2B, in one example embodiment, the user's interaction and resulting input may be a swipe from one instrument image in the instrument carousel to another instrument image in the carousel. In another example embodiment, the input may be a tap in a predefined area of the interface.

At step 352, the mobile device 310 displays an instrument image in accordance with the inputs received from a user via the interface of the mobile device 310. The instrument image is associated with an AID stored on the memory of the mobile device 310. The instrument image and its corresponding AID are also associated with an applet and corresponding set of credentials on a secure element 320 associated with the mobile device 310.

At step 354, the mobile device 310 determines the AID associated with the instrument image displayed on the interface of the mobile device. To determine the AID, the mobile device may perform a query in its memory to determine which AID is associated with the instrument image displayed.

Once the mobile device 310 determines and retrieves the AID from its memory, the mobile device transmits, at step 356, a request to the secure element 320 to enable an applet corresponding to the retrieved AID. The request may include the AID of the instrument image displayed on the interface.

In an example embodiment, the request at step 356 may also include at least one of a select command, an authentication command, and a settings command. These commands are described in more detail in U.S. patent application Ser. No. 13/857,400, entitled “Systems, Methods, and Computer Program Products for Securing and Managing Applications on Secure Elements,” which is incorporated herein by reference in its entirety.

The select command may include the AID of the applet to be enabled (i.e. the AID corresponding to the instrument image displayed in the mobile wallet). The secure element may send a response back to the mobile device as to whether the select command was accepted, or whether an error occurred.

The authentication command may include either a parity check, a verification of a passcode, or the like. The authentication command will verify the security settings of the mobile wallet application versus the security settings stored on the secure element. If the authentication command is successful, the applet in the secure element will be placed into an authenticated state. For example, a user may enter a verification passcode to enter the mobile wallet. When the mobile device transmits a first request to the secure element, it will also transmit the passcode entered by a user and ask the secure element to verify it against the passcode saved within the secure element. If the passcode is verified, the applet will be placed into an authenticated state.

The settings command transmitted in the first request may include instructions to select the applet, which has been authenticated, corresponding to the AID included in the request as the primary applet. The applet being set to the primary applet allows that applet to be enabled for contactless transactions.

In another embodiment, the first request 356 may also include a request to a contactless registry service (CRS) applet. The CRS applet may manage applets on the secure element. The request to the CRS applet may include a select command and a set status command. The select command includes the AID of the applet corresponding to the card image displayed on the interface. The set status command includes an AID, status (e.g. activate, deactivated, etc.), and instructions to set the status of the applet corresponding to the AID to activated.

In yet another embodiment, the mobile wallet may include a Wallet Companion Applet (WCAp) on the corresponding secure element. The WCAp may be used to monitor, manage, and/or secure certain types of applications associated with the mobile wallet, such as payment applets for making financial transactions or commerce applets for performing tasks associated with processing loyalty, offer, membership, or account data. The WCAp may also be used to manage the requests sent to the secure element as described above. The WCAp is more fully described in U.S. patent application Ser. No. 13/857,400, entitled “Systems, Methods, and Computer Program Products for Securing and Managing Applications on Secure Elements,” which is incorporated herein by reference in its entirety.

The secure element 320 determines the applet corresponding to the AID, at step 358, and may enable the applet, at step 360. As discussed above, each instrument image in the carousel corresponds to an applet (and credentials) on the secure memory 320, each of which is assigned its own unique AID. The determination at 358 may include a query within the memory of the secure element 320 for the applet corresponding to the AID that was sent in the first request 356. After the secure element 320 determines the applet, the secure element 320 may enable the applet at step 360. It does so by changing a parameter associated with the applet from an inactive parameter to an active parameter, such as, for example, from “disabled” to “enabled.” If the parameter is changed to an activated state, the credentials associated with that applet will be enabled for a contactless transaction. Enabling applets within a secure element is described in more detail in U.S. patent application Ser. No. 13/857,400, entitled “Systems, Methods, and Computer Program Products for Securing and Managing Applications on Secure Elements,” which is incorporated herein by reference in its entirety.

The mobile device 310 then receives a response at step 362 from the secure element 320 indicating whether or not the applet corresponding to the AID is enabled. The mobile device 310 may then show this status on the interface within the mobile wallet application, as described above in reference to FIGS. 2A and 2C. The mobile device may also include an instruction to the user to perform a contactless transaction.

### IV. Computer Readable Medium Implementation

The example embodiments described above such as, for example, the systems and procedures depicted in or discussed in connection with FIGS. 1-3 or any part or function thereof, may be implemented by using hardware, software or a combination of the two. The implementation may be in one or more computers or other processing systems. While manipulations performed by these example embodiments may have been referred to in terms commonly associated with mental operations performed by a human operator, no human operator is needed to perform any of the operations described herein. In other words, the operations may be completely implemented with machine operations. Useful machines for performing the operation of the example embodiments presented herein include general purpose digital computers or similar devices.

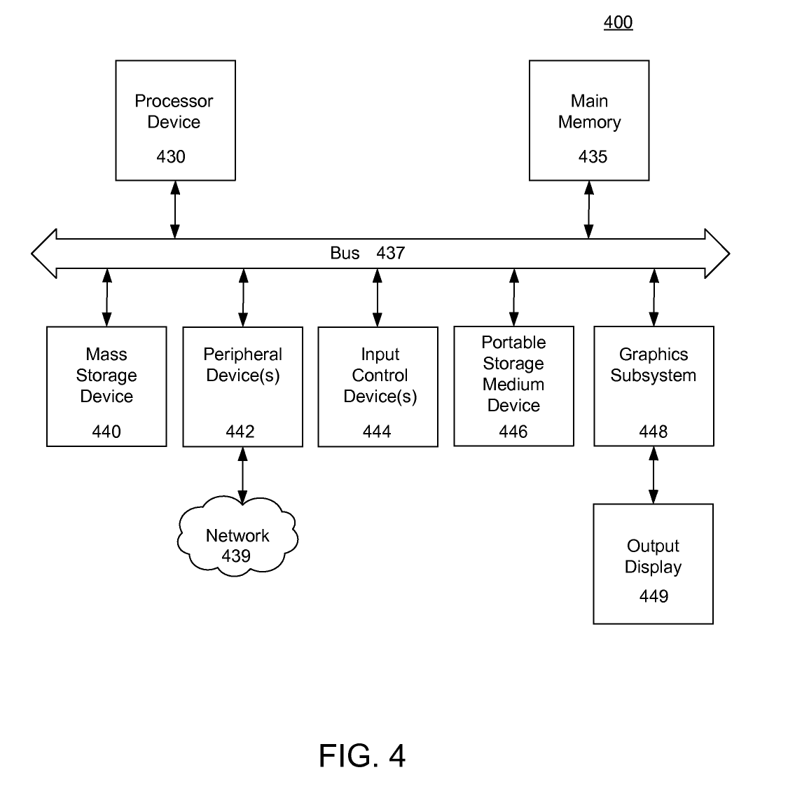

FIG. 4 is a block diagram of a general and/or special purpose computer 400, in accordance with some of the example embodiments of the invention. The computer 400 may be, for example, a user device, a user computer, a client computer and/or a server computer, among other things.

The computer 400 may include without limitation a processor device 430, a main memory 435, and an interconnect bus 437. The processor device 430 may include without limitation a single microprocessor, or may include a plurality of microprocessors for configuring the computer 400 as a multi-processor system. The main memory 435 stores, among other things, instructions and/or data for execution by the processor device 430. The main memory 435 may include banks of dynamic random access memory (DRAM), as well as cache memory.

The computer 400 may further include a mass storage device 440, peripheral device(s) 442, portable storage medium device(s) 446, input control device(s) 444, a graphics subsystem 448, and/or an output display 449. For explanatory purposes, all components in the computer 400 are shown in FIG. 4 as being coupled via the bus 437. However, the computer 400 is not so limited. Devices of the computer 400 may be coupled via one or more data transport means. For example, the processor device 430 and/or the main memory 435 may be coupled via a local microprocessor bus. The mass storage device, 440, peripheral device(s) 442, portable storage medium device(s) 446, and/or graphics subsystem 448 may be coupled via one or more input/output (I/O) buses. The mass storage device 440 may be a nonvolatile storage device for storing data and/or instructions for use by the processor device 430. The mass storage device 440 may be implemented, for example, with a magnetic disk drive or an optical disk drive. In a software embodiment, the mass storage device 440 is configured for loading contents of the mass storage device 440 into the main memory 435.

The portable storage medium device 446 operates in conjunction with a nonvolatile portable storage medium, such as, for example, a compact disc read only memory (CD-ROM), to input and output data and code to and from the computer 400. In some embodiments, the software for storing an internal identifier in metadata may be stored on a portable storage medium, and may be inputted into the computer 400 via the portable storage medium device 446. The peripheral device(s) 442 may include any type of computer support device, such as, for example, an input/output (I/O) interface configured to add additional functionality to the computer 400. For example, the peripheral device(s) 442 may include a network interface card for interfacing the computer 400 with a network 439.

The input control device(s) 444 provide a portion of the user interface for a user of the computer 400. The input control device(s) 444 may include a keypad and/or a cursor control device. The keypad may be configured for inputting alphanumeric characters and/or other key information. The cursor control device may include, for example, a mouse, a trackball, a stylus, and/or cursor direction keys. In order to display textual and graphical information, the computer 400 may include the graphics subsystem 448 and the output display 449. The output display 449 may include a cathode ray tube (CRT) display and/or a liquid crystal display (LCD). The graphics subsystem 448 receives textual and graphical information, and processes the information for output to the output display 449.

Each component of the computer 400 may represent a broad category of a computer component of a general and/or special purpose computer. Components of the computer 400 are not limited to the specific implementations provided here.

Portions of the example embodiments of the invention may be conveniently implemented by using a conventional general purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a DVD, a CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further include software for performing example aspects of the invention, as described above.

Included in the programming and/or software of the general and/or special purpose computer or microprocessor are software modules for implementing the procedures described above.

While various example embodiments of the invention have been described above, it should be understood that they have been presented by way of example, and not limitation. It is apparent to persons skilled in the relevant art(s) that various changes in form and detail can be made therein. Thus, the invention should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures. Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A system for enabling a set of credentials, the system comprising:
a memory operable to store one or more application identifiers (AIDs),
an interface,
and a processor communicatively coupled to the memory and the interface,
the processor being operable to:
receive an input via the interface, the input including instructions to display a first instrument image corresponding to a first set of credentials on the interface;
retrieve, from the memory, an AID corresponding to the instrument image displayed on the interface;
transmit a first request to a secure element to enable an applet corresponding to the AID, the first request including the AID of the instrument image displayed on the interface; and
receive a first response from the secure element indicating whether the applet corresponding to the AID is enabled.

2. The system according to claim 1, wherein the system further comprises the secure element, the secure element including a secure element processor and a secure element memory;
the secure element processor being operable to enable the applet corresponding to the AID included in the first request.

3. The system according to claim 1, wherein the instruction included in the input is a swipe from a second instrument image displayed on the interface to the first instrument image.

4. The system according to claim 1, wherein the instrument is at least one of (i) a credit card, (ii) a debit card, and (iii) a loyalty card.

5. The system according to claim 1, wherein the first request includes one of a select command, an authentication command, and a settings command;
the select command including an AID of the credentials to be enabled in the secure element;
the authentication command including at least one of a parity check and a verification of a passcode, wherein if the authentication command is successful, the applet in the secure element will be placed into an authenticated state; and
the settings command including instructions to select the applet corresponding to the AID included in the command as the primary applet.

6. The system according to claim 5, wherein the request to the secure element further includes a request to a contactless registry service (CRS) applet to enable the applet corresponding to the AID.

7. A method for enabling a set of credentials, the method comprising the steps of:
receiving an input from an interface, the input including instructions to display a first instrument image corresponding to a first set of credentials on the interface;
retrieving, from a memory, an application identifier (AID) corresponding to the first instrument image displayed on the interface;
transmitting a first request to a secure element to enable an applet corresponding to the AID, the first request including the AID of the instrument image displayed on the interface; and
receiving a first response from the secure element indicating whether the applet corresponding to the AID is enabled.

8. The method according to claim 7, wherein the method further comprises:
a secure element processor enabling the applet corresponding to the AID included in the first request.

9. The method according to claim 7, wherein the instruction included in the input is a swipe from a second instrument image displayed on the interface to the first instrument image.

10. The method according to claim 7, wherein the instrument is at least one of (i) a credit card, (ii) a debit card, and (iii) a loyalty card.

11. The method according to claim 7, wherein the first request to the secure element includes one of a select command, an authentication command, and a settings command;
the select command including an AID of the credentials to be enabled in the secure element;
the authentication command including at least one of a parity check and a verification of a passcode, wherein if the authentication command is successful, the applet in the secure element will be placed into an authenticated state; and
the settings command including instructions to select the applet corresponding to the AID included in the command as the primary applet.

12. The method according to claim 11, wherein the request to the secure element further includes a request to a contactless registry service (CRS) applet to enable the applet corresponding to the AID.

13. A non-transitory computer-readable medium having stored thereon sequences of instructions for causing one or more processors to:
receive an input via the interface, the input including instructions to display a first instrument image corresponding to a first set of credentials on the interface;
retrieve, from the memory, an AID corresponding to the first instrument image displayed on the interface;
transmit a first request to a secure element to enable an applet corresponding to the AID, the first request including the AID of the instrument image displayed on the interface; and
receive a first response from the secure element indicating whether the applet corresponding to the AID is enabled.

14. The computer-readable medium according to claim 13, wherein the computer-readable medium further having stored thereon sequences of instructions for causing a secure element processor to:
enable the applet corresponding to the AID of the credentials included in the first request.

15. The computer-readable medium according to claim 13, wherein the instruction included in the input is a swipe from a second instrument image displayed on the interface to the first instrument image.

16. The computer-readable medium according to claim 13, wherein the instrument is at least one of (i) a credit card, (ii) a debit card, and (iii) a loyalty card.

17. The computer-readable medium according to claim 13, wherein the request to the secure element includes one of a select command, an authentication command, and a settings command;
the select command including an AID of the credentials to be enabled in the secure element;
the authentication command including at least one of a parity check and a verification of a passcode, wherein if the authentication command is successful, the applet in the secure element will be placed into an authenticated state; and
the settings command including instructions to select the applet corresponding to the AID included in the command as the primary applet.

18. The computer-readable medium according to claim 17, wherein the request to the secure element further includes a request to a contactless registry service (CRS) applet to enable the applet corresponding to the AID.
